(19) United States
(12) Patent Application Publication
(10) Pub. No.: US 2025/0388196 A1
(43) Pub. Date: Dec. 25, 2025

(54) BRAKE APPARATUS AND METHOD OF CONTROLLING THE SAME

(71) Applicant: HL MANDO CORPORATION, Pyeongtaek-si (KR)

(72) Inventors: Kwanseek KIM, Pyeongtaek-si (KR); Kyungran CHO, Pyeongtaek-si (KR)

(73) Assignee: HL MANDO CORPORATION, Pyeongtaek-si (KR)

(21) Appl. No.: 19/233,769

(22) Filed: Jun. 10, 2025

(30) Foreign Application Priority Data
Jun. 21, 2024 (KR) 10-2024-0081257
Dec. 3, 2024 (KR) 10-2024-0177170

(51) Int. Cl. B60T 7/12; B60T 7/04

(52) U.S. Cl. CPC B60T 7/12; B60T 7/045; B60T 2201/03

(57) ABSTRACT

A brake apparatus and a method of controlling the same includes electronic parking brakes (EPB) installed in the rear wheels of a vehicle, first and second parking drive circuits for operating respective EPB motors, first and second switch parts, and a control unit. The first switch part, positioned between the first EPB motor and first parking drive circuit, includes switches to selectively control current flow between both drive circuits and the first motor. The second switch part similarly controls current flow between both drive circuits and the second motor. The control unit operates both EPB motors through the respective drive circuits. Upon identifying a failure in either drive circuit, the control unit adjusts the corresponding switch part and enables operation of both EPB motors using the remaining functional drive circuit, thereby maintaining brake performance through a degradation control mode.

### CROSS-REFERENCE TO RELATED APPLICATIONS

This application claims the priority of Korean Patent Application No. 10-2024-0081257 filed on Jun. 21, 2024, in the Korean Intellectual Property Office, and Korean Patent Application No. 10-2024-0177170 filed on Dec. 3, 2024, in the Korean Intellectual Property Office, the disclosure of which is incorporated herein by reference.

### BACKGROUND

### Technical Field

The disclosed disclosure relates to a brake apparatus and a method of controlling the same.

### Description of the Related Art

In current vehicle technologies, braking systems play very important roles in terms of safety and performance. In particular, an integrated dynamic brake (IDB) provides more stable braking performance by combining a basic braking function and an electric parking brake (EPB) function. The IDB system is a key element that not only brakes the vehicle while the vehicle generally travels, but also safely fixes the vehicle when the vehicle is parked.

In case that a problem occurs on a basic braking system (BBS) of an IDB controller, a degradation braking (degradation BBS) function is performed by operating an EPB function to ensure the safety of the vehicle. The degradation braking function is an important safety mechanism that may safely stop the vehicle in the event of a failure of a main braking system.

### BRIEF SUMMARY

The disclosed brake apparatus provides a fault-tolerant control system for electronic parking brakes by allowing either of two parking drive circuits to operate both rear-wheel EPB motors if one circuit becomes non-functional. This is accomplished through the use of switch components that connect each motor to both circuits and can redirect electrical current based on system status. If a failure is detected using current sensors, the remaining operational drive circuit automatically takes control of both motors and adjusts the current level to maintain proper braking force.

Control is managed by two microcontrollers, each overseeing one parking drive circuit while monitoring the overall system and communicating with the other controller. This structure enables automatic failover, coordinated control, and consistent braking performance in the event of partial system failure. The approach combines electrical redundancy and intelligent control to enhance safety without requiring additional motors or complex rewiring.

Various embodiments of the disclosure provide a brake apparatus capable of performing a normal degradation braking mode even if any one of two parking drive circuits of an electronic parking brake, which is performing a degradation braking mode, fails, and a method of controlling the same.

Various embodiments of the disclosure provide a brake apparatus, in which a normal parking drive circuit, which does not fail, operates two EPB motors to minimize a decrease in braking force, and a method of controlling the same.

One aspect of the disclosed disclosure provides a brake apparatus including: an electronic parking brake (EPB) installed in each rear wheel of a vehicle; a first parking drive circuit configured to operate a first EPB motor of the electronic parking brake; a second parking drive circuit configured to operate a second EPB motor of the electronic parking brake; a first switch part provided between the first EPB motor and the first parking drive circuit and including first and second switches configured to selectively control an electric current flow between the first parking drive circuit and the first EPB motor and an electric current flow between the second parking drive circuit and the first EPB motor; a second switch part provided between the second EPB motor and the second parking drive circuit and including third and fourth switches configured to selectively control an electric current flow between the second parking drive circuit and the second EPB motor and an electric current flow between the first parking drive circuit and the second EPB motor; and a control unit configured to control the first parking drive circuit and the second parking drive circuit to operate the first EPB motor and the second EPB motor, in which when a failure of any one of the first parking drive circuit and the second parking drive circuit is identified, the control unit controls the switch part connected to any one parking drive circuit with the identified failure and control the other parking drive circuit to operate the first EPB motor and the second EPB motor.

The control unit may include a first controller configured to control the first parking drive circuit, and a second controller configured to control the second parking drive circuit.

The brake apparatus may further include a first current sensor configured to detect an electric current supplied to the first parking drive circuit from an external power source, and a second current sensor configured to detect an electric current supplied to the second parking drive circuit from the external power source.

The first controller may identify a failure of the first parking drive circuit on the basis of a signal detected by the first current sensor, and the second controller may identify a failure of the second parking drive circuit on the basis of a signal detected by the second current sensor.

The first switch part may be connected to a line configured to connect the second switch part and the second EPB motor, and the second switch part may be connected to a line configured to connect the first switch part and the first EPB motor.

The first switch part may be configured to allow the electric current flow between the first parking drive circuit and the first EPB motor and cut off the electric current flow between the second parking drive circuit and the first EPB motor in a default state, and the second switch part may be configured to allow the electric current flow between the second parking drive circuit and the second EPB motor and cut off the electric current flow between the first parking drive circuit and the second EPB motor in a default state.

The first controller may control the first parking drive circuit to operate the first EPB motor and the second EPB motor in response to the identification of the failure of the second parking drive circuit.

When a failure of the second parking drive circuit is identified, the second controller may control the second EPB driving part to switch the second switch part and transmit a signal, which indicates the failure of the second parking drive circuit, to the first controller, and the first controller may increase an electric current to be applied to the first parking drive circuit by an electric current value (in some embodiments, selected or predetermined) in response to the reception of the signal indicating the failure of the second parking drive circuit.

The second controller may control the second parking drive circuit to operate the first EPB motor and the second EPB motor in response to the identification of the failure of the first parking drive circuit.

When a failure of the first parking drive circuit is identified, the first controller may control the first EPB driving part to switch the first switch part and transmit a signal, which indicates the failure of the first parking drive circuit, to the second controller, and the second controller may increase an electric current to be applied to the second parking drive circuit by an electric current value (in some embodiments, selected or predetermined) in response to the reception of the signal indicating the failure of the first parking drive circuit.

The first controller and the second controller may identify states thereof, and when a failure of any one of the first controller and the second controller is identified, the other controller may control the parking drive circuit, which corresponds to the other controller, to operate the first EPB motor and the second EPB motor.

Another aspect of the disclosed disclosure provides a method of controlling a brake apparatus, the method including identifying a failure of any one of a first parking drive circuit, which is configured to operate a first EPB motor of an electronic parking brake (EPB) installed in each rear wheel of a vehicle, and a second parking drive circuit configured to operate a second EPB motor; and controlling a switch part connected to any one parking drive circuit with an identified failure and controlling the other parking drive circuit to operate the first EPB motor and the second EPB motor when the failure of any one parking drive circuit is identified, the switch part being one of a first switch part provided between the first EPB motor and the first parking drive circuit and including first and second switches configured to selectively control an electric current flow between the first parking drive circuit and the first EPB motor and an electric current flow between the first parking drive circuit and the second EPB motor and a second switch part provided between the second EPB motor and the second parking drive circuit and including third and fourth switches configured to selectively control an electric current flow between the second parking drive circuit and the second EPB motor and an electric current flow between the second parking drive circuit and the first EPB motor.

The identifying of the failure of any one parking drive circuit may include identifying, by first and second controllers, a failure of any one of the first parking drive circuit and the second parking drive circuit on the basis of signals detected by first and second current sensors configured to detect electric currents supplied to the first parking drive circuit and the second parking drive circuit from an external power source.

The first switch part may be connected to a line configured to connect the second switch part and the second EPB motor, the second switch part may be connected to a line configured to connect the first switch part and the first EPB motor, and the controlling may include controlling, by the first controller, the first parking drive circuit to operate the first EPB motor and the second EPB motor in response to the identification of the failure of the second parking drive circuit.

The controlling may further include controlling, by the second controller, the second EPB driving part to switch the second switch part when the failure of the second parking drive circuit is identified, and transmitting a signal, which indicates the failure of the second parking drive circuit, to the first controller.

The controlling may further include increasing, by the first controller, an electric current to be applied to the first parking drive circuit by an electric current value (in some embodiments, selected or predetermined) in response to the reception of the signal indicating the failure of the second parking drive circuit.

The controlling may further include controlling, by the second controller, the second parking drive circuit to operate the first EPB motor and the second EPB motor in response to the identification of the failure of the first parking drive circuit.

The controlling may further include controlling, by the first controller, the first EPB driving part to switch the first switch part when the failure of the first parking drive circuit is identified; and transmitting a signal, which indicates the failure of the first parking drive circuit, to the second controller.

The controlling may further include increasing, by the second controller, an electric current to be applied to the second parking drive circuit by an electric current value (in some embodiments, selected or predetermined) in response to the reception of the signal indicating the failure of the first parking drive circuit.

The method may further include identifying, by the first controller and the second controller, states thereof.

The method may further include controlling the parking drive circuit corresponding to the other controller so that the other controller operates the first EPB motor and the second EPB motor when a failure of any one of the first controller and the second controller is identified.

The effects of the present disclosure are not limited to the aforementioned effects, and other effects, which are not mentioned above, will be apparently understood to a person having ordinary skill in the art from the following description.

Aspects of the present disclosure described above do not specify essential features of the claims, and, thus, the scope of the claims is not limited to the disclosure of the present disclosure.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a view illustrating hydraulic and electrical control of a brake apparatus according to an embodiment;

FIG. 2 is a view illustrating a control configuration of the brake apparatus according to the embodiment;

FIG. 3 is a view illustrating an EPB circuit diagram of the brake apparatus according to the embodiment;

FIG. 4 is a view illustrating a signal flow in the EPB circuit diagram in case that a first parking drive circuit of the brake apparatus according to the embodiment fails;

FIG. 5 is a view illustrating a signal flow in the EPB circuit diagram in case that a second parking drive circuit of the brake apparatus according to the embodiment fails;

FIG. 6 is a view illustrating an operation of the brake apparatus according to the embodiment;

FIG. 7 is a view more specifically illustrating some operations of the brake apparatus in FIG. 6;

FIG. 8 is a view illustrating an EPB circuit diagram of a brake apparatus according to another embodiment;

FIG. 9 is a view illustrating a signal flow in an EPB circuit diagram in case that a first parking drive circuit of the brake apparatus according to another embodiment fails; and

FIG. 10 is a view illustrating a signal flow in the EPB circuit diagram in case that a second parking drive circuit of the brake apparatus according to another embodiment fails.

### DETAILED DESCRIPTION

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part,’ ‘module,’ ‘member,’ ‘block,’ and the like as used in the specification may be implemented in software or hardware. Further, a plurality of ‘part,’ ‘module,’ ‘member,’ ‘block,’ and the like may be embodied as one component. It is also possible that one ‘part,’ ‘module,’ ‘member,’ ‘block,’ and the like includes a plurality of components.

The term “unit” or “module” as used herein may include any electrical circuitry, features, components, an assembly of electronic components, or the like. That is, “unit” or “module” may include any processor-based system including systems using microcontrollers, integrated circuits, chips, microchips, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit” or “module.”

In some embodiments, the various units or modules described herein may be included in or otherwise implemented by processing circuitry such as a microprocessor, microcontroller, or the like.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

As used herein, the term “connected” is intended to have the broadest possible meaning. Specifically, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and “in contact” should be interpreted in the same manner.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

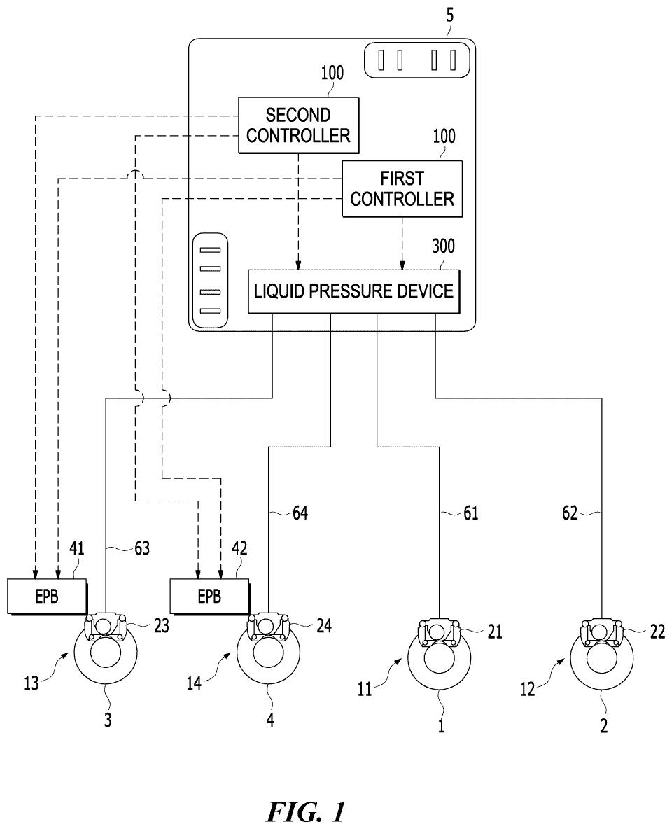

FIG. 1 illustrates hydraulic and electrical control of a brake apparatus according to an embodiment.

As illustrated in FIG. 1, brake discs, which are configured to rotate together with wheels 1, 2, 3, and 4, are respectively provided in the wheels 1, 2, 3, and 4, and brake calipers 11, 12, 13, and 14 are provided to stop the rotations of the wheels 1, 2, 3, and 4. For example, the brake calipers 11, 12, 13, and 14 may each include a pair of brake pads provided at two opposite sides of the brake disc and configured to press the brake disc.

The brake calipers 11, 12, 13, and 14 include wheel cylinders 21, 22, 23, and 24 each configured to accommodate liquid pressure and allow the pair of brake pads to press the brake disc. For example, the wheel cylinders 21, 22, 23, and 24 may include a first wheel cylinder 21 installed on a first brake caliper 11, a second wheel cylinder 22 installed on a second brake caliper 12, a third wheel cylinder 23 installed on a third brake caliper 13, and a fourth wheel cylinder 24 installed on a fourth brake caliper 14.

Electronic parking brakes 41 and 42 may be provided in at least some of the brake calipers 11, 12, 13, and 14. For example, the electronic parking brakes 41 and 42 may be provided in the third and fourth brake calipers 13 and 14 among the brake calipers 11, 12, 13, and 14. The first electronic parking brake 41 may be provided in the third brake caliper 13, and the second electronic parking brake 42 may be provided in the fourth brake caliper 14.

The first and second electronic parking brakes 41 and 42 may each have a means capable of moving the brake pad by an electromechanical force without liquid pressure. For example, the first and second electronic parking brakes 41 and 42 may include first and second EPB motors having rotary shafts, and spindles configured to be reciprocated by rotations of the rotary shafts. The spindle may reciprocate the brake pad by the rotation of the rotary shaft.

The first and second electronic parking brakes 41 and 42 may each press the brake pad toward the brake disc in response to an engagement signal. In addition, the first and second electronic parking brakes 41 and 42 may each move the brake pad away from the brake disc in response to a disengagement signal.

The brake apparatus includes a liquid pressure device 300 configured to generate liquid pressure for braking the vehicle, and first and second controllers 100 and 200 configured to control an operation of the liquid pressure device 300.

The liquid pressure device 300 may generate the liquid pressure for generating braking forces for the wheels 1, 2, 3, and 4. For example, the liquid pressure device 300 may detect the driver's braking intention by means of a brake pedal 5. The liquid pressure device 300 may generate the liquid pressure on the basis of a movement distance and/or a movement speed of the brake pedal 5 and provide the generated liquid pressure to the wheel cylinders 21, 22, 23, and 24 through transmission flow paths 61, 62, 63, and 64. The transmission flow paths 61, 62, 63, and 64 include a first transmission flow path 61 connected to the first wheel cylinder 21, a second transmission flow path 62 connected to the second wheel cylinder 22, a third transmission flow path 63 connected to the third wheel cylinder 23, and a fourth transmission flow path 64 connected to the fourth wheel cylinder 24.

The internal pressure of the wheel cylinders 21, 22, 23, and 24 may depend on the liquid pressure provided by the liquid pressure device 300. The braking forces may be applied to the wheels 1, 2, 3, and 4 depending on the internal pressure of the wheel cylinders 21, 22, 23, and 24.

The first controller 100 and the second controller 200 may control the operation of the liquid pressure device 300. For example, the first controller 100 and the second controller 200 may control a liquid pressure supply device (not illustrated) to generate the liquid pressure on the basis of an output of a pedal displacement sensor PTS.

The first controller 100 and the second controller 200 may control the first and second electronic parking brakes 41 and 42. The first controller 100 and the second controller 200 may provide engagement signals to the first and second electronic parking brakes 41 and 42 to engage the electronic parking brakes in response to the driver's engagement instruction inputted through a parking button or the like. Alternatively, the first controller 100 and the second controller 200 may provide disengagement signals to the first and second electronic parking brakes 41 and 42 to disengage the electronic parking brakes in response to the driver's disengagement instruction inputted through the parking button or the like.

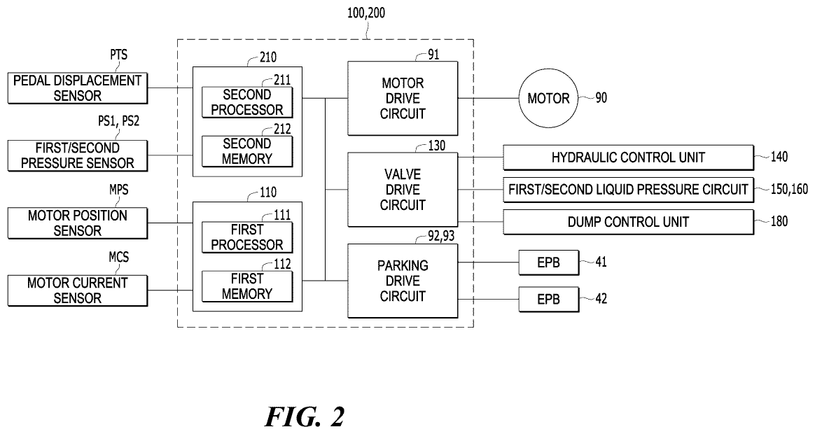

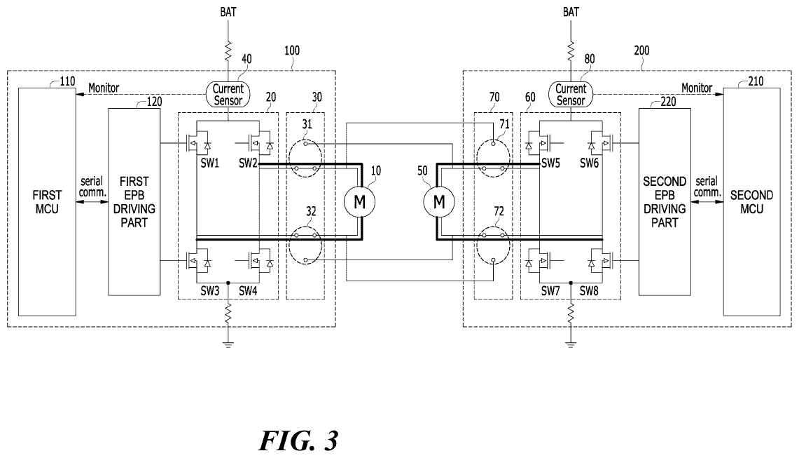

FIG. 2 illustrates a control configuration of the brake apparatus according to the embodiment, and FIG. 3 illustrates an EPB circuit diagram of the brake apparatus according to the embodiment.

With reference to FIG. 2, the brake apparatus may include a motor 90, a hydraulic control unit 140, first and second liquid pressure circuits 150 and 160, a dump control unit 180, the first and second electronic parking brakes 41 and 42, the pedal displacement sensor PTS, first and second pressure sensors PS1 and PS2, a motor position sensor MPS, a motor current sensor MCS, a motor drive circuit 91, a valve drive circuit 130, first and second parking drive circuits 92 and 93, and first and second MCUs 110 and 210. The above-mentioned components are not essential components of the brake apparatus, and at least some of the above-mentioned components may be excluded.

The motor 90 may include a rotary shaft provided rotatably. The motor 90 may include a rotor connected to the rotary shaft, and a stator fixed to a housing. For example, the rotor may include permanent magnets having N-poles and S-poles alternately disposed along an outer surface thereof, and the stator may include a plurality of teeth disposed along the outer surface of the rotor, and a plurality of coils configured to surround the plurality of teeth, respectively.

The rotor may be rotated by a magnetic interaction with the stator, and the rotation of the rotor may be provided to the rotary shaft. The motor 90 may receive a drive current controlled by the motor drive circuit 91. The plurality of coils included in the stator may form a magnetic field rotated at the periphery of the rotor by the drive current, and the rotor may be rotated by a magnetic interaction between the magnetic field of the rotor and the magnetic field of the stator.

The hydraulic control unit 140, the first and second liquid pressure circuits 150 and 160, and the dump control unit 180 may control flow paths extending from a master cylinder or a liquid pressure supply unit to the wheel cylinders 21, 22, 23, and 24.

The hydraulic control unit 140, the first and second liquid pressure circuits 150 and 160, and the dump control unit 180 may receive drive currents controlled by the valve drive circuit 130. The hydraulic control unit 140, the first and second liquid pressure circuits 150 and 160, and the dump control unit 180 may each include at least one solenoid valve configured to be opened or closed by the drive current. The solenoid valve may include a plunger configured to open or close the flow path, a spring configured to apply an elastic force to the plunger, and a coil configured to surround the plunger. The coil may form a magnetic field by the drive current, and the plunger may be moved against the elastic force of the spring by the magnetic field of the coil. Therefore, the solenoid valve may be opened or closed.

The first and second electronic parking brakes 41 and 42 may each have a means capable of moving the brake pad by an electromechanical force without liquid pressure. For example, the first and second electronic parking brakes 41 and 42 may include first and second EPB motors 10 and 50 having rotary shafts, and spindles configured to be reciprocated by rotations of the rotary shafts. The spindle may reciprocate the brake pad by the rotation of the rotary shaft.

The first and second EPB motors 10 and 50 respectively included in the first and second electronic parking brakes 41 and 42 may receive the drive currents controlled by the first and second parking drive circuits 92 and 93. The first and second EPB motors 10 and 50 respectively included in the first and second electronic parking brakes 41 and 42 may each press the brake pad toward the brake disc or move the brake pad away from the brake disc by the drive current.

The pedal displacement sensor PTS may be installed in the vicinity of the brake pedal 5 and measure the movement of the brake pedal 5 made by the driver's braking intention. For example, the pedal displacement sensor PTS may detect a movement distance and/or a movement speed of the brake pedal 5 from a reference position.

The pedal displacement sensor PTS may be electrically connected to first and second processors 111 and 211 and provide the first and second processors 111 and 211 with electrical signals (pedal displacement signals) corresponding to the movement distance and/or the movement speed of the brake pedal 5. For example, the pedal displacement sensor PTS may be connected directly to the first and second processors 111 and 211 through hard wires or connected to the first and second processors 111 and 211 through a communication network.

The first pressure sensor PS1 may measure the liquid pressure discharged from the liquid pressure supply unit. The first pressure sensor PS1 may be connected directly to the first and second processors 111 and 211 through hard wires or connected to the first and second processors 111 and 211 through a communication network. The first pressure sensor PS1 may provide the first and second processors 111 and 211 with electrical signals (second pressure signals) corresponding to the measured liquid pressure.

The second pressure sensor PS2 may measure the liquid pressure discharged from the master cylinder. The second pressure sensor PS2 may be connected directly to the first and second processors 111 and 211 through hard wires or connected to the first and second processors 111 and 211 through a communication network. The second pressure sensor PS2 may provide the first and second processors 111 and 211 with electrical signals (first pressure signals) corresponding to the measured liquid pressure.

The motor position sensor MPS may measure a rotation angle of the rotor of the motor 90. For example, the motor position sensor MPS may include a Hall sensor. The Hall sensors may detect periodic changes in magnetic fields caused by the rotations of the permanent magnets of the rotor. The motor position sensor MPS may be connected directly to the first and second processors 111 and 211 through hard wires or connected to the first and second processors 111 and 211 through a communication network. The motor position sensor MPS may provide the first and second processors 111 and 211 with electrical signals (motor position signals) corresponding to the measured rotation angle.

The motor current sensor MCS may measure a drive current value supplied to the motor 90. For example, the motor current sensor MCS may include a shunt resistor and a voltage distribution circuit and measure a drive current value supplied to the motor 90 by using the shunt resistor and the voltage distribution circuit. The motor current sensor MCS may be connected directly to the first and second processors 111 and 211 through hard wires or connected to the first and second processors 111 and 211 through a communication network. The motor current sensor MCS may provide the first and second processors 111 and 211 with electrical signals (motor current signals) corresponding to the measured drive current value.

The motor drive circuit 91 may control the drive current supplied to the motor 90 in response to the motor control signal of the first processor 111 or the second processor 211. For example, the motor drive circuit 91 may include a three-phase inverter including a plurality of switching elements configured to control drive currents supplied to the motor 90, and an inverter driver configured to control the plurality of switching elements included in the three-phase inverter in response to the motor control signal of the first processor 111 or the second processor 211. The inverter driver may provide the switching elements of the three-phase inverter with the motor driving signal for operating the three-phase inverter in response to the motor control signal of the first processor 111 or the second processor 211. The three-phase inverter may convert direct current power, which is supplied from a battery of the vehicle, into alternating current power in response to a motor driving signal of the inverter driver and provide the converted alternating current power to the motor 90.

The valve drive circuit 130 may control drive currents supplied to valves included in the hydraulic control unit 140, the first and second liquid pressure circuits 150 and 160, and the dump control unit 180 in response to the valve control signal of the first processor 111 or the second processor 211. For example, the valve drive circuit 130 may include a switching element configured to control drive currents supplied to the valves, and a switching driver configured to control the switching element in response to the valve control signal of the first processor 111 or the second processor 211.

The first and second parking drive circuits 92 and 93 may control drive currents supplied to the first and second EPB motors 10 and 50 included in the first and second electronic parking brakes 41 and 42 in response to parking control signals (parking engagement signals and parking disengagement signals) of the first and second processors 111 and 211. For example, the first and second parking drive circuits 92 and 93 may include first and second H-bridge circuits 20 and 60 including a plurality of switching elements SW1, SW2, SW3, SW4, SW5, SW6, SW7, and SW8 configured to control drive currents supplied to the first and second EPB motors 10 and 50, and first and second H-bridge drivers (first and second EPB driving parts) 120 and 220 configured to control the plurality of switching elements SW1, SW2, SW3, SW4, SW5, SW6, SW7, and SW8 included in the first and second H-bridge circuits 20 and 60 in response to the parking control signals of the first and second processors 111 and 211.

The first and second processors 111 and 211 may provide control signals for controlling operations of the components included in the brake apparatus in accordance with the driver's braking intention.

The first and second processors 111 and 211 may include first and second memories 112 and 212 configured to store or memorize programs and data for implementing the operation of controlling the components included in the brake apparatus.

The first and second memories 112 and 212 may provide the stored program and data to the first and second processors 111 and 211 and memorize temporary data produced during the operations of the first and second processors 111 and 211. For example, the first and second memories 112 and 212 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The first and second processors 111 and 211 may be electrically connected to the pedal displacement sensor PTS, the first and second pressure sensors PS1 and PS2, the motor position sensor MPS, the motor current sensor MCS, the motor drive circuit 91, the valve drive circuit 130, and parking drive circuits 92 and 93.

The first and second processors 111 and 211 may process electrical signals received from the pedal displacement sensor PTS, the first and second pressure sensors PS1 and PS2, the motor position sensor MPS, and the motor current sensor MCS and provide motor control signals, valve control signals, and parking control signals (or degradation control signals) to the motor drive circuit 91, the valve drive circuit 130, and the first and second parking drive circuits 92 and 93 on the basis of the processed electrical signals.

For example, the first and second processors 111 and 211 may determine target liquid pressure to be provided to the wheel cylinders 21, 22, 23, and 24 on the basis of the pedal displacement signal of the pedal displacement sensor PTS and provide the motor control signal to the motor drive circuit 91 to move a liquid pressure piston in response to the target pressure. In addition, the first and second processors 111 and 211 may determine measured pressure on the basis of a first pressure signal of the first pressure sensor PS1 and provide the motor control signal to the motor drive circuit 91 to move the liquid pressure piston on the basis of a difference between the measured pressure and the target pressure.

Hereinafter, a configuration of an EPB circuit of the brake apparatus and signal flows according to operating states will be described with reference to FIGS. 3 to 5.

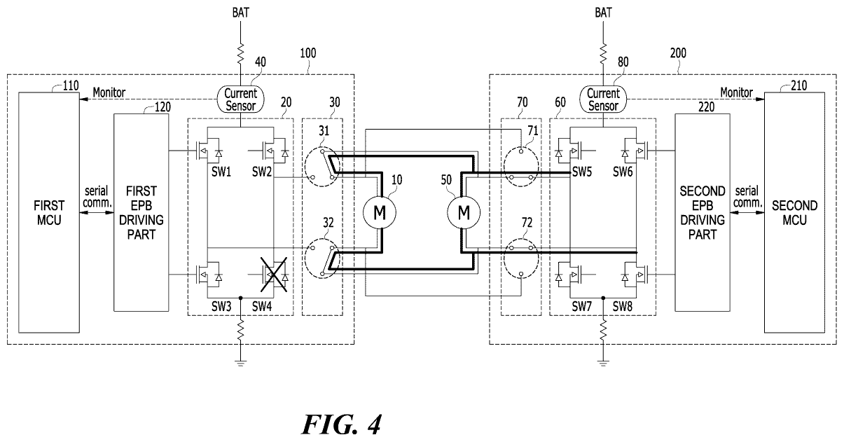

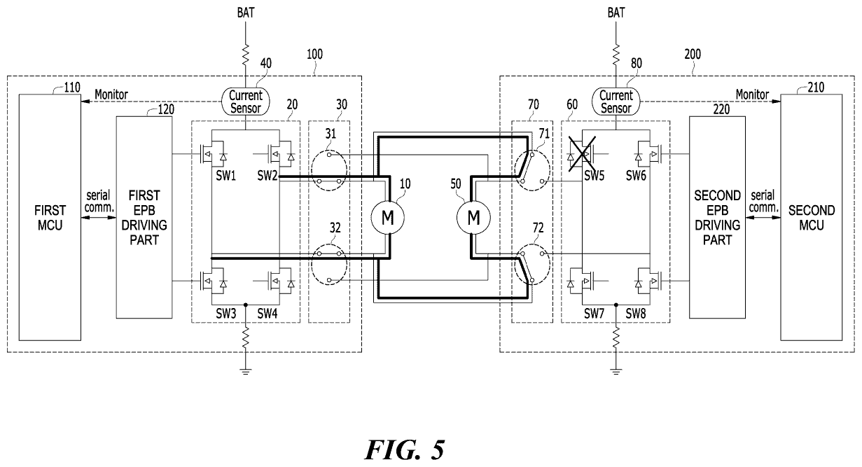

FIG. 3 illustrates a signal flow when the EPB circuit of the brake apparatus operates normally, FIG. 4 illustrates a signal flow in case that a first parking drive circuit of the EPB circuit of the brake apparatus fails, and FIG. 5 illustrates a signal flow in case that a second parking drive circuit of the EPB circuit of the brake apparatus fails.

With reference to FIG. 3, the EPB circuit of the brake apparatus may include the first controller 100 including a first MCU 110, a first EPB driving part 120, a first H-bridge circuit 20, a first switch part 30, and a first current sensor 40, a first EPB motor 10, the second controller 200 including a second MCU 210, a second EPB driving part 220, a second H-bridge circuit 60, a second switch part 70, and a second current sensor 80, and a second EPB motor 50.

The first MCU 110 may be connected to the first EPB driving part 120 and provide the parking control signal or the degradation control signal to the first EPB driving part 120 to operate the first EPB motor 10. For example, the first MCU 110 may provide the parking control signal to the first EPB driving part 120 in a general parking situation. In addition, the first MCU 110 may provide the degradation control signal to the first EPB driving part 120 in a situation in which degradation control is required.

To this end, the first MCU 110 may identify a failure of the motor drive circuit 91 or the valve drive circuit 130. The first MCU 110 may identify a failure of an electrohydraulic brake by identifying a failure of the motor drive circuit 91 or the valve drive circuit 130. When a failure of the electrohydraulic brake is identified as described above, the first MCU 110 may provide the degradation control signal to the first EPB driving part 120 to perform a degradation control mode.

The first parking drive circuit 92 may include the first H-bridge circuit 20 including the plurality of switching elements SW1, SW2, SW1, and SW4 configured to control the drive currents supplied to the first EPB motor 10, and the first EPB driving part (or the first H-bridge driver) 120 configured to control the plurality of switching elements SW1, SW2, SW1, and SW4 included in the first H-bridge circuit 20 in response to the parking control signal or the degradation control signal of the first MCU 110.

The first EPB driving part 120 may control the drive current supplied to the first EPB motor 10 included in the first electronic parking brake 41 in response to the parking control signal (the parking engagement signal and the parking disengagement signal) or the degradation control signal received from the first MCU 110.

The first switch part 30 may be provided between the first H-bridge circuit 20 and the first EPB motor 10. The first switch part 30 may be configured to selectively control an electric current flow between the first parking drive circuit 92 (or the first H-bridge circuit 20) and the first EPB motor 10 and an electric current flow between the second parking drive circuit 93 (or the second H-bridge circuit 60) and the first EPB motor 10. For example, in accordance with whether the first switch part 30 is turned on or off, the first switch part 30 may be configured to cut off or allow the electric current flow between the first parking drive circuit 92 (or the first H-bridge circuit 20) and the first EPB motor 10 and allow or cut off the electric current flow between the second parking drive circuit 93 (or the second H-bridge circuit 60) and the first EPB motor 10.

When the first switch part 30 is in the ON state, the first switch part 30 may cut off the electric current flow between the first parking drive circuit 92 (or the first H-bridge circuit 20) and the first EPB motor 10 and allow the electric current flow between the second parking drive circuit 93 (or the second H-bridge circuit 60) and the first EPB motor 10.

The first switch part 30 may include first and second line switches 31 and 32 respectively provided on two lines that connect the first H-bridge circuit 20 and the first EPB motor 10.

In other words, when the first and second line switches 31 and 32 are in the ON state, the first and second line switches 31 and 32 may cut off the electric current flow between the first parking drive circuit 92 (or the first H-bridge circuit 20) and the first EPB motor 10 and allow the electric current flow between the second parking drive circuit 93 (or the second H-bridge circuit 60) and the first EPB motor 10.

When the first switch part 30 is in the OFF state, the first switch part 30 may allow the electric current flow between the first parking drive circuit 92 (or the first H-bridge circuit 20) and the first EPB motor 10 and cut off the electric current flow between the second parking drive circuit 93 (or the second H-bridge circuit 60) and the first EPB motor 10.

That is, when the first and second line switches 31 and 32 included in the first switch part 30 are in the OFF state, the first and second line switches 31 and 32 may allow the electric current flow between the first parking drive circuit 92 (or the first H-bridge circuit 20) and the first EPB motor 10 and cut off the electric current flow between the second parking drive circuit 93 (or the second H-bridge circuit 60) and the first EPB motor 10.

When the first parking drive circuit 92 (or the first H-bridge circuit 20) is in the normal state, the first switch part 30 may operate in the OFF state that is a default state.

When the first parking drive circuit 92 (or the first H-bridge circuit 20) fails, the first switch part 30 may switch from the OFF state to the ON state.

In this case, when a failure of the first parking drive circuit 92 (or the first H-bridge circuit 20) is identified, the first MCU 110 may control the operation of the first switch part 30. That is, the first MCU 110 may provide the control signal to the first EPB driving part 120 to switch the first and second line switches 31 and 32 of the first switch part 30 from the OFF state to the ON state.

According to another embodiment, in accordance with whether the first switch part 30 is turned on or off, the first switch part 30 may be configured to allow or cut off the electric current flow between the first parking drive circuit 92 (or the first H-bridge circuit 20) and the first EPB motor 10 and cut off or allow the electric current flow between the second parking drive circuit 93 (or the second H-bridge circuit 60) and the first EPB motor 10.

When the first switch part 30 is in the ON state, the first switch part 30 may allow the electric current flow between the first parking drive circuit 92 (or the first H-bridge circuit 20) and the first EPB motor 10 and cut off the electric current flow between the second parking drive circuit 93 (or the second H-bridge circuit 60) and the first EPB motor 10.

In other words, when the first and second line switches 31 and 32 are in the ON state, the first and second line switches 31 and 32 may allow the electric current flow between the first parking drive circuit 92 (or the first H-bridge circuit 20) and the first EPB motor 10 and cut off the electric current flow between the second parking drive circuit 93 (or the second H-bridge circuit 60) and the first EPB motor 10.

When the first switch part 30 is in the OFF state, the first switch part 30 may cut off the electric current flow between the first parking drive circuit 92 (or the first H-bridge circuit 20) and the first EPB motor 10 and allow the electric current flow between the second parking drive circuit 93 (or the second H-bridge circuit 60) and the first EPB motor 10.

That is, when the first and second line switches 31 and 32 included in the first switch part 30 are in the ON state, the first and second line switches 31 and 32 may allow the electric current flow between the first parking drive circuit 92 (or the first H-bridge circuit 20) and the first EPB motor 10 and cut off the electric current flow between the second parking drive circuit 93 (or the second H-bridge circuit 60) and the first EPB motor 10.

When the first parking drive circuit 92 (or the first H-bridge circuit 20) is in the normal state, the first switch part 30 may operate in the ON state that is a default state.

When the first parking drive circuit 92 (or the first H-bridge circuit 20) fails, the first switch part 30 may switch from the ON state to the OFF state.

The first MCU 110 may identify whether any one of the plurality of switching elements SW1, SW2, SW1, and SW4 included in the first parking drive circuit 92, more specifically, the first H-bridge circuit 20 fails while the degradation control mode is performed. To this end, the first MCU 110 may receive an electric current value from the first current sensor 40 configured to detect an electric current supplied to the first H-bridge circuit 20. On the basis of the electric current value received from the first current sensor 40, the first MCU 110 may identify whether any one of the plurality of switching elements SW1, SW2, SW1, and SW4 included in the first H-bridge circuit 20 fails.

According to the embodiment, a voltage sensor (not illustrated), instead of a current sensor, may be used to identify whether any one of the plurality of switching elements SW1, SW2, SW1, and SW4 included in the first H-bridge circuit 20 fails.

The second MCU 210 may be connected to the second EPB driving part 220 and provide the parking control signal or the degradation control signal to the second EPB driving part 220 to operate the second EPB motor 50. For example, the second MCU 210 may provide the parking control signal to the second EPB driving part 220 in the general parking situation. In addition, the second MCU 210 may provide the degradation control signal to the second EPB driving part 220 in the situation in which degradation control is required.

To this end, the second MCU 210 may identify a failure of the motor drive circuit 91 or the valve drive circuit 130. The second MCU 210 may identify a failure of an electrohydraulic brake by identifying a failure of the motor drive circuit 91 or the valve drive circuit 130. When a failure of the electrohydraulic brake is identified as described above, the second MCU 210 may provide the degradation control signal to the second EPB driving part 220 to perform the degradation control mode.

The second parking drive circuit 93 may include the second H-bridge circuit 60 including the plurality of switching elements SW5, SW6, SW7, and SW8 configured to control the drive currents supplied to the second EPB motor 50, and the second EPB driving part (or second H-bridge driver) 220 configured to control the plurality of switching elements SW5, SW6, SW7, and SW8 included in the second H-bridge circuit 60 in response to the parking control signal or the degradation control signal of the second MCU 210.

The second EPB driving part 220 may control the drive current supplied to the second EPB motor 50 included in the second electronic parking brake 42 in response to the parking control signal (the parking engagement signal and the parking disengagement signal) or the degradation control signal received from the second MCU 210.

The second switch part 70 may be provided between the second H-bridge circuit 60 and the second EPB motor 50. The second switch part 70 may be configured to selectively control an electric current flow between the second parking drive circuit 93 (or the second H-bridge circuit 60) and the second EPB motor 50 and an electric current flow between the first parking drive circuit 92 (or the first H-bridge circuit 20) and the second EPB motor 50. For example, in accordance with whether the second switch part 70 is turned on or off, the second switch part 70 may be configured to cut off or allow the electric current flow between the second parking drive circuit 93 (or the second H-bridge circuit 60) and the second EPB motor 50 and allow or cut off the electric current flow between the first parking drive circuit 92 (or the first H-bridge circuit 20) and the second EPB motor 50.

When the second switch part 70 is in the ON state, the second switch part 70 may cut off the electric current flow between the second parking drive circuit 93 (or the second H-bridge circuit 60) and the second EPB motor 50 and allow the electric current flow between the first parking drive circuit 92 (or the first H-bridge circuit 20) and the second EPB motor 50.

The second switch part 70 may include third and fourth line switches 71 and 72 respectively provided on two lines that connect the second H-bridge circuit 60 and the second EPB motor 50.

In other words, when the third and fourth line switches 71 and 72 are in the ON state, the third and fourth line switches 71 and 72 may cut off the electric current flow between the second parking drive circuit 93 (or the second H-bridge circuit 60) and the second EPB motor 50 and allow the electric current flow between the first parking drive circuit 92 (or the first H-bridge circuit 20) and the second EPB motor 50.

When the second switch part 70 is in the OFF state, the second switch part 70 may allow the electric current flow between the second parking drive circuit 93 (or the second H-bridge circuit 60) and the second EPB motor 50 and cut off the electric current flow between the first parking drive circuit 92 (or the first H-bridge circuit 20) and the second EPB motor 50.

That is, when the third and fourth line switches 71 and 72 included in the second switch part 70 are in the OFF state, the third and fourth line switches 71 and 72 may allow the electric current flow between the second parking drive circuit 93 (or the second H-bridge circuit 60) and the second EPB motor 50 and cut off the electric current flow between the first parking drive circuit 92 (or the first H-bridge circuit 20) and the second EPB motor 50.

When the second parking drive circuit 93 (or the second H-bridge circuit 60) is in the normal state, the second switch part 70 may operate in the OFF state that is a default state.

When the second parking drive circuit 93 (or the second H-bridge circuit 60) fails, the second switch part 70 may switch from the OFF state to the ON state.

In this case, when a failure of the second parking drive circuit 93 (or the second H-bridge circuit 60) is identified, the second MCU 210 may control the operation of the second switch part 70. That is, the second MCU 210 may provide the control signal to the second EPB driving part 220 to switch the third and fourth line switches 71 and 72 of the second switch part 70 from the OFF state to the ON state.

According to another embodiment, in accordance with whether the second switch part 70 is turned on or off, the second switch part 70 may be configured to allow or cut off the electric current flow between the second parking drive circuit 93 (or the second H-bridge circuit 60) and the second EPB motor 50 and cut off or allow the electric current flow between the first parking drive circuit 92 (or the first H-bridge circuit 20) and the second EPB motor 50.

When the second switch part 70 is in the ON state, the second switch part 70 may allow the electric current flow between the second parking drive circuit 93 (or the second H-bridge circuit 60) and the second EPB motor 50 and cut off the electric current flow between the first parking drive circuit 92 (or the first H-bridge circuit 20) and the second EPB motor 50.

In other words, when the third and fourth line switches 71 and 72 are in the ON state, the third and fourth line switches 71 and 72 may allow the electric current flow between the second parking drive circuit 93 (or the second H-bridge circuit 60) and the second EPB motor 50 and cut off the electric current flow between the first parking drive circuit 92 (or the first H-bridge circuit 20) and the second EPB motor 50.

When the second switch part 70 is in the OFF state, the second switch part 70 may cut off the electric current flow between the second parking drive circuit 93 (or the second H-bridge circuit 60) and the second EPB motor 50 and allow the electric current flow between the first parking drive circuit 92 (or the first H-bridge circuit 20) and the second EPB motor 50.

That is, when the third and fourth line switches 71 and 72 included in the second switch part 70 are in the OFF state, the third and fourth line switches 71 and 72 may cut off the electric current flow between the second parking drive circuit 93 (or the second H-bridge circuit 60) and the second EPB motor 50 and allow the electric current flow between the first parking drive circuit 92 (or the first H-bridge circuit 20) and the second EPB motor 50.

When the second parking drive circuit 93 (or the second H-bridge circuit 60) is in the normal state, the second switch part 70 may operate in the ON state that is a default state.

When the second parking drive circuit 93 (or the second H-bridge circuit 60) fails, the second switch part 70 may switch from the ON state to the OFF state.

The second MCU 210 may identify whether any one of the plurality of switching elements SW5, SW6, SW7, and SW8 included in the second parking drive circuit 93, more specifically, the second H-bridge circuit 60 fails while the degradation control mode is performed. To this end, the second MCU 210 may receive an electric current value from the second current sensor 80 configured to detect an electric current supplied to the second H-bridge circuit 60. On the basis of the electric current value received from the second current sensor 80, the second MCU 210 may identify whether any one of the plurality of switching elements SW5, SW6, SW7, and SW8 included in the second H-bridge circuit 60 fails.

According to the embodiment, a voltage sensor (not illustrated), instead of a current sensor, may be used to identify whether any one of the plurality of switching elements SW5, SW6, SW7, and SW8 included in the second H-bridge circuit 60 fails.

According to the embodiment, the first MCU 110 and the second MCU 210 may monitor states thereof through internal communication (private communication).

The first MCU 110 and the second MCU 210 may notify whether the first parking drive circuit 92 (or the first H-bridge circuit 20) and the second parking drive circuit 93 (or the second H-bridge circuit 60) fail.

When the first MCU 110 receives, from the second MCU 210, a signal indicating a failure of the second parking drive circuit 93 (or the second H-bridge circuit 60), the first MCU 110 may increase the electric current to be applied to the first parking drive circuit 92 (or the first H-bridge circuit 20) by a value (in some embodiments, selected or predetermined).

When the second MCU 210 receives, from the first MCU 110, a signal indicating a failure of the first parking drive circuit 92 (or the first H-bridge circuit 20), the second MCU 210 may increase the electric current to be applied to the second parking drive circuit 93 (or the second H-bridge circuit 60) by a value (in some embodiments, selected or predetermined).

An operation of the EPB circuit in case that the switching element SW4, among the components of the first parking drive circuit 92, fails will be described with reference to FIG. 4.

The first MCU 110 may identify a failure of the first parking drive circuit 92 (or the first H-bridge circuit 20) on the basis of a change in electric current value received from the first current sensor 40. Therefore, the first MCU 110 may transmit a signal, which indicates a failure of the first parking drive circuit 92 (or the first H-bridge circuit 20), to the second MCU 210. In addition, the first MCU 110 may provide a line switch control signal to the first EPB driving part 120 so that the first and second line switches 31 and 32 of the first switch part 30 operate in the ON state. In this case, the first and second line switches 31 and 32 of the first switch part 30 may switch from the OFF state, which is the default state, to the ON state.

Because the first and second line switches 31 and 32 switch to the ON state, the first EPB motor 10 may be electrically connected to the second parking drive circuit 93 through the first and second line switches 31 and 32 and placed in an operable state.

On the basis that the second MCU 210 receives, from the first MCU 110, the signal indicating a failure of the first parking drive circuit 92 (or the first H-bridge circuit 20), the second MCU 210 may increase the electric current to be applied to the second parking drive circuit 93 (or the second H-bridge circuit 60) by a value (in some embodiments, selected or predetermined).

Therefore, the electric current sufficient for both the first and second EPB motors 10 and 50 to operate in the degradation control mode is supplied through the second parking drive circuit 93, such that the degradation control may be performed without abnormality even in the event of the failure of the first parking drive circuit 92.

According to another embodiment, the default state of the first and second line switches 31 and 32 of the first switch part 30 may be the ON state. In this case, because the first and second line switches 31 and 32 naturally switch from the ON state, which is the default state, to the OFF state when the first parking drive circuit 92 (or the first H-bridge circuit 20) fails, the first MCU 110 does not need to provide a separate line switch control signal.

An operation of the EPB circuit in case that the switching element SW5, among the components of the second parking drive circuit 93, fails will be described with reference to FIG. 5.

The second MCU 210 may identify a failure of the second parking drive circuit 93 (or the second H-bridge circuit 60) on the basis of a change in electric current value received from the second current sensor 80. Therefore, the second MCU 210 may transmit a signal, which indicates a failure of the second parking drive circuit 93 (or the second H-bridge circuit 60), to the first MCU 110. In addition, the second MCU 210 may provide the line switch control signal to the second EPB driving part 220 so that the third and fourth line switches 71 and 72 of the second switch part 70 operate in the ON state. In this case, the third and fourth line switches 71 and 72 of the second switch part 70 may switch from the OFF state, which is the default state, to the ON state.

Because the third and fourth line switches 71 and 72 switch to the ON state, the second EPB motor 50 may be electrically connected to the first parking drive circuit 92 through the third and fourth line switches 71 and 72 and placed in an operable state.

On the basis that the first MCU 110 receives, from the second MCU 210, the signal indicating a failure of the second parking drive circuit 93 (or the second H-bridge circuit 60), the first MCU 110 may increase the electric current to be applied to the first parking drive circuit 92 (or the first H-bridge circuit 20) by a value (in some embodiments, selected or predetermined).

Therefore, the electric current sufficient for both the first and second EPB motors 10 and 50 to operate in the degradation control mode is supplied through the first parking drive circuit 92, such that the degradation control may be performed without abnormality even in the event of the failure of the second parking drive circuit 93.

According to another embodiment, the default state of the third and fourth line switches 71 and 72 of the second switch part 70 may be the ON state. In this case, because the third and fourth line switches 71 and 72 naturally switch from the ON state, which is the default state, to the OFF state when the second parking drive circuit 93 (or the second H-bridge circuit 60) fails, the second MCU 210 does not need to provide a separate line switch control signal.

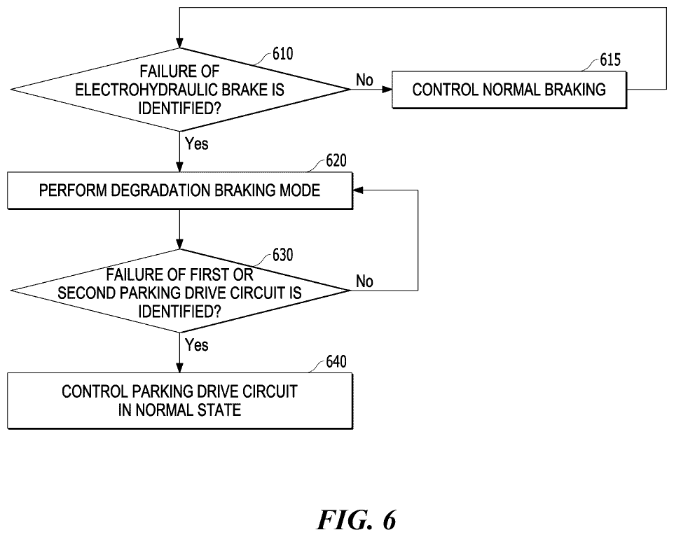

FIG. 6 illustrates an operation of the brake apparatus according to the embodiment.

With reference to FIG. 6, the operation of the brake apparatus according to the embodiment may include performing the degradation braking mode (620) when a failure of the electrohydraulic brake is identified (YES in 610), and controlling the other parking drive circuit when a failure of any one of the first and second parking drive circuits 92 and 93 is identified (YES in 630).

The identifying of the electrohydraulic brake (610) may be performed as the first MCU 110 or the second MCU 210 identifies a failure of the motor drive circuit 91 or the valve drive circuit 130.

The performing of the degradation braking mode (620) may include providing, by the first and second MCUs 110 and 210, the degradation control signals to the first and second EPB driving parts 120 and 220 to perform the degradation control mode.

The identifying of the failure of any one of the first and second parking drive circuits 92 and 93 (630) may be performed on the basis of the electric current values applied to the first and second parking drive circuits 92 and 93. For example, when a change rate of the electric current value applied to the first parking drive circuit 92 is equal to or higher than a reference change rate, a failure of the first parking drive circuit 92 may be identified. Alternatively, when a change rate of the electric current value applied to the second parking drive circuit 93 is equal to or higher than the reference change rate, a failure of the second parking drive circuit 932 may be identified.

The controlling of another (normal state) parking drive circuit (640) may include controlling the corresponding parking drive circuit to operate the first and second EPB motors 10 and 50. For example, when a failure of the first parking drive circuit 92 is identified, the second MCU 210 may control the second parking drive circuit 93 to operate the first and second EPB motors 10 and 50. Alternatively, when a failure of the second parking drive circuit 93 is identified, the first MCU 110 may control the first parking drive circuit 92 to operate the first and second EPB motors 10 and 50.

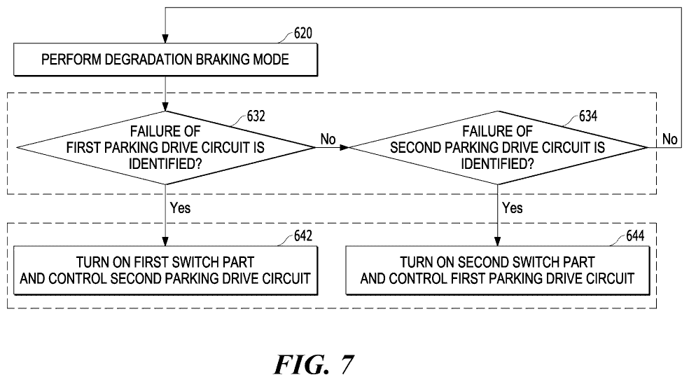

FIG. 7 more specifically illustrates some operations of the brake apparatus in FIG. 6.

With reference to FIG. 7, the identifying of the failure of any one of the first and second parking drive circuits 92 and 93 (630) may include identifying whether the first parking drive circuit 92 fails (632), and identifying whether the second parking drive circuit 93 fails (634) when a failure of the first parking drive circuit 92 is not identified (NO in 632).

The controlling of another (normal state) parking drive circuit (640) may include turning on the first switch part 30 and controlling the second parking drive circuit 93 (642) when a failure of the first parking drive circuit 92 is identified (YES in 632), and turning on the second switch part 70 and controlling the first parking drive circuit 92 (644) when a failure of the second parking drive circuit 93 is identified (YES 634).

The turning on of the first switch part 30 and controlling of the second parking drive circuit 93 (642) may include increasing the electric current to be applied to the second parking drive circuit 93 (or the second H-bridge circuit 60) by a value (in some embodiments, selected or predetermined).

The turning on of the second switch part 70 and controlling of the first parking drive circuit 92 (644) may include increasing the electric current to be applied to the first parking drive circuit 92 (or the first H-bridge circuit 20) by a value (in some embodiments, selected or predetermined).

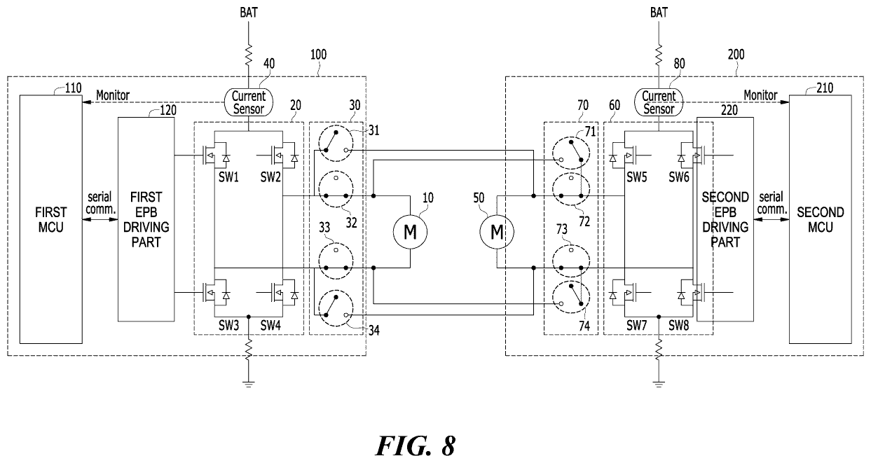

Hereinafter, a configuration of an EPB circuit of a brake apparatus and signal flows according to operating states according to another embodiment of the present disclosure will be described with reference to FIGS. 8 to 10.

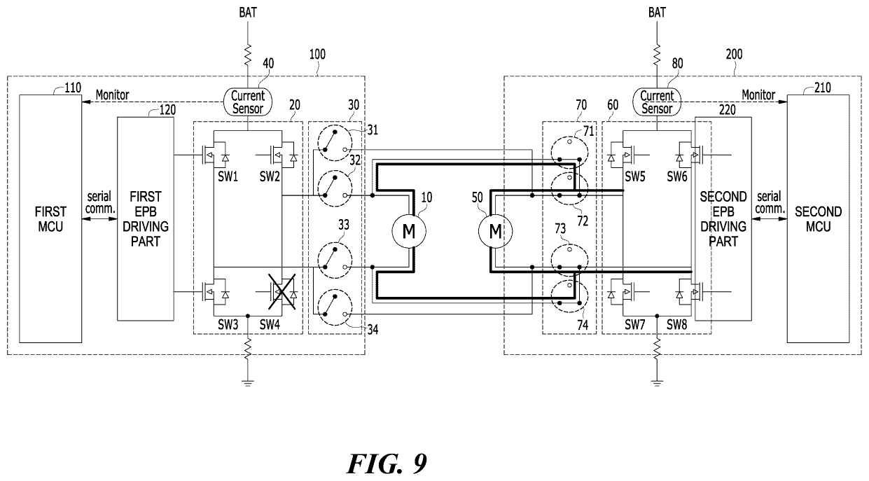

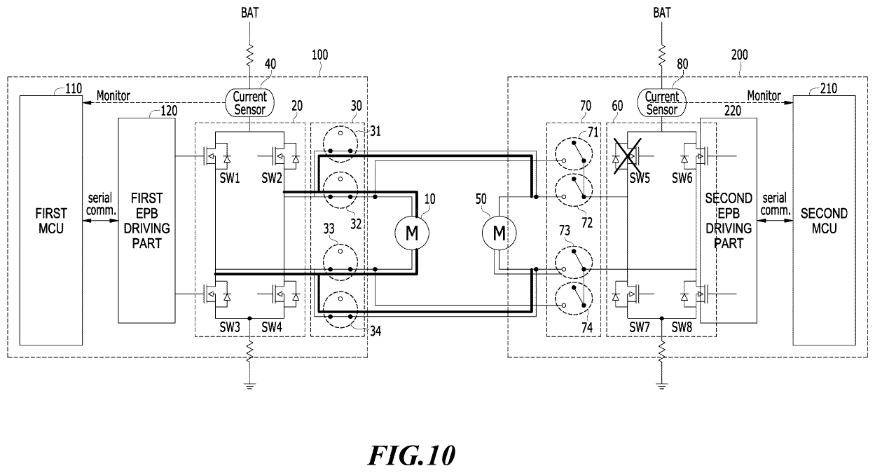

FIG. 8 illustrates an EPB circuit diagram of the brake apparatus according to another embodiment, FIG. 9 illustrates a signal flow in an EPB circuit diagram in case that a first parking drive circuit of the brake apparatus according to another embodiment fails, and FIG. 10 illustrates a signal flow in the EPB circuit diagram in case that a second parking drive circuit of the brake apparatus according to another embodiment fails.

With reference to FIG. 8, the EPB circuit of the brake apparatus according to another embodiment of the present disclosure may include the first controller 100 including the first MCU 110, the first EPB driving part 120, the first H-bridge circuit 20, the first switch part 30, and the first current sensor 40, the first EPB motor 10, the second controller 200 including the second MCU 210, the second EPB driving part 220, the second H-bridge circuit 60, the second switch part 70, and the second current sensor 80, and the second EPB motor 50.

The first MCU 110 may be connected to the first EPB driving part 120 and provide the parking control signal or the degradation control signal to the first EPB driving part 120 to operate the first EPB motor 10. For example, the first MCU 110 may provide the parking control signal to the first EPB driving part 120 in a general parking situation. In addition, the first MCU 110 may provide the degradation control signal to the first EPB driving part 120 in the situation in which degradation control is required.

To this end, the first MCU 110 may identify a failure of the motor drive circuit 91 or the valve drive circuit 130. The first MCU 110 may identify a failure of the electrohydraulic brake by identifying a failure of the motor drive circuit 91 or the valve drive circuit 130. When a failure of the electrohydraulic brake is identified as described above, the first MCU 110 may provide the degradation control signal to the first EPB driving part 120 to perform the degradation control mode.

The first parking drive circuit 92 may include the first H-bridge circuit 20 including the plurality of switching elements SW1, SW2, SW1, and SW4 configured to control the drive currents supplied to the first EPB motor 10, and the first EPB driving part (or the first H-bridge driver) 120 configured to control the plurality of switching elements SW1, SW2, SW1, and SW4 included in the first H-bridge circuit 20 in response to the parking control signal or the degradation control signal of the first MCU 110.

The first EPB driving part 120 may control the drive current supplied to the first EPB motor 10 included in the first electronic parking brake 41 in response to the parking control signal (the parking engagement signal and the parking disengagement signal) or the degradation control signal received from the first MCU 110.

The first switch part 30 may be provided between the first H-bridge circuit 20 and the first EPB motor 10. The first switch part 30 may be configured to selectively control the electric current flow between the first parking drive circuit 92 (or the first H-bridge circuit 20) and the first EPB motor 10 and the electric current flow between the first parking drive circuit 92 (or the first H-bridge circuit 20) and the second EPB motor 50. For example, in accordance with whether the first switch part 30 is turned on or off, the first switch part 30 may be configured to cut off or allow the electric current flow between the first parking drive circuit 92 (or the first H-bridge circuit 20) and the first EPB motor 10 and allow or cut off the electric current flow between the first parking drive circuit 92 (or the first H-bridge circuit 20) and the second EPB motor 50.

The first switch part 30 may include second and third line switches 32 and 33 respectively provided on two lines configured to connect the first H-bridge circuit 20 and the first EPB motor 10, and first and fourth line switches 33 and 34 respectively provided on two lines configured to connect the first H-bridge circuit 20 and the second EPB motor 50.

When the second and third line switches 32 and 33 are in the OFF state, the second and third line switches 32 and 33 may allow the electric current flow between the first parking drive circuit 92 (or the first H-bridge circuit 20) and the first EPB motor 10. When the first and fourth line switches 31 and 34 are in the ON state, the first and fourth line switches 31 and 34 may cut off the electric current flow between the first parking drive circuit 92 (or the first H-bridge circuit 20) and the second EPB motor 50.

In other words, when the first parking drive circuit 92 (or the first H-bridge circuit 20) is in the normal state, the second and third line switches 32 and 33 of the first switch part 30 may operate in the OFF state that is the default state, and the first and fourth line switches 31 and 34 of the first switch part 30 may operate in the ON state.

When the first parking drive circuit 92 (or the first H-bridge circuit 20) fails, the second and third line switches 32 and 33 of the first switch part 30 may switch from the OFF state to the ON state, and the first and fourth line switches 31 and 34 of the first switch part 30 may be kept in the ON state.

In this case, when a failure of the first parking drive circuit 92 (or the first H-bridge circuit 20) is identified, the first MCU 110 may control the operation of the first switch part 30. That is, the first MCU 110 may provide the control signal to the first EPB driving part 120 to switch the second and third line switches 32 and 33 of the first switch part 30 from the OFF state to the ON state.

According to another embodiment, when the second and third line switches 32 and 33 are in the ON state, the second and third line switches 32 and 33 may allow the electric current flow between the first parking drive circuit 92 (or the first H-bridge circuit 20) and the first EPB motor 10. When the first and fourth line switches 31 and 34 are in the OFF state, the first and fourth line switches 31 and 34 may cut off the electric current flow between the first parking drive circuit 92 (or the first H-bridge circuit 20) and the second EPB motor 50.

In other words, when the first parking drive circuit 92 (or the first H-bridge circuit 20) is in the normal state, the second and third line switches 32 and 33 of the first switch part 30 may operate in the ON state that is the default state, and the first and fourth line switches 31 and 34 of the first switch part 30 may operate in the OFF state.

When the first parking drive circuit 92 (or the first H-bridge circuit 20) fails, the second and third line switches 32 and 33 of the first switch part 30 may switch from the ON state to the OFF state, and the first and fourth line switches 31 and 34 of the first switch part 30 may be kept in the OFF state.

In this case, when a failure of the first parking drive circuit 92 (or the first H-bridge circuit 20) is identified, the first MCU 110 may control the operation of the first switch part 30. That is, the first MCU 110 may provide the control signal to the first EPB driving part 120 to switch the second and third line switches 32 and 33 of the first switch part 30 from the ON state to the OFF state.

The first MCU 110 may identify whether any one of the plurality of switching elements SW1, SW2, SW1, and SW4 included in the first parking drive circuit 92, more specifically, the first H-bridge circuit 20 fails while the degradation control mode is performed. To this end, the first MCU 110 may receive an electric current value from the first current sensor 40 configured to detect an electric current supplied to the first H-bridge circuit 20. On the basis of the electric current value received from the first current sensor 40, the first MCU 110 may identify whether any one of the plurality of switching elements SW1, SW2, SW1, and SW4 included in the first H-bridge circuit 20 fails.

According to the embodiment, a voltage sensor (not illustrated), instead of a current sensor, may be used to identify whether any one of the plurality of switching elements SW1, SW2, SW1, and SW4 included in the first H-bridge circuit 20 fails.

The second MCU 210 may be connected to the second EPB driving part 220 and provide the parking control signal or the degradation control signal to the second EPB driving part 220 to operate the second EPB motor 50. For example, the second MCU 210 may provide the parking control signal to the second EPB driving part 220 in the general parking situation. In addition, the second MCU 210 may provide the degradation control signal to the second EPB driving part 220 in the situation in which degradation control is required.

To this end, the second MCU 210 may identify a failure of the motor drive circuit 91 or the valve drive circuit 130. The second MCU 210 may identify a failure of an electrohydraulic brake by identifying a failure of the motor drive circuit 91 or the valve drive circuit 130. When a failure of the electrohydraulic brake is identified as described above, the second MCU 210 may provide the degradation control signal to the second EPB driving part 220 to perform the degradation control mode.

The second parking drive circuit 93 may include the second H-bridge circuit 60 including the plurality of switching elements SW5, SW6, SW7, and SW8 configured to control the drive currents supplied to the second EPB motor 50, and the second EPB driving part (or second H-bridge driver) 220 configured to control the plurality of switching elements SW5, SW6, SW7, and SW8 included in the second H-bridge circuit 60 in response to the parking control signal or the degradation control signal of the second MCU 210.

The second EPB driving part 220 may control the drive current supplied to the second EPB motor 50 included in the second electronic parking brake 42 in response to the parking control signal (the parking engagement signal and the parking disengagement signal) or the degradation control signal received from the second MCU 210.

The second switch part 70 may be provided between the second H-bridge circuit 60 and the second EPB motor 50. The second switch part 70 may be configured to selectively control the electric current flow between the second parking drive circuit 93 (or the second H-bridge circuit 60) and the second EPB motor 50 and the electric current flow between the second parking drive circuit 93 (or the second H-bridge circuit 60) and the first EPB motor 10. For example, in accordance with whether the second switch part 70 is turned on or off, the second switch part 70 may be configured to cut off or allow the electric current flow between the second parking drive circuit 93 (or the second H-bridge circuit 60) and the second EPB motor 50 and allow or cut off the electric current flow between the second parking drive circuit 93 (or the second H-bridge circuit 60) and the first EPB motor 10.

The second switch part 70 may include sixth and seventh line switches 72 and 73 respectively provided on two lines configured to connect the second H-bridge circuit 60 and the second EPB motor 50, and fifth and eighth line switches 71 and 74 respectively provided on two lines configured to connect the second H-bridge circuit 60 and the first EPB motor 10.

When the sixth and seventh line switches 72 and 73 are in the OFF state, the sixth and seventh line switches 72 and 73 may allow the electric current flow between the second parking drive circuit 93 (or the second H-bridge circuit 60) and the second EPB motor 50. When the fifth and eighth line switches 71 and 74 are in the ON state, the fifth and eighth line switches 71 and 74 may cut off the electric current flow between the second parking drive circuit 93 (or the second H-bridge circuit 60) and the first EPB motor 10.

In other words, when the second parking drive circuit 93 (or the second H-bridge circuit 60) is in the normal state, the sixth and seventh line switches 72 and 73 of the second switch part 70 may operate in the OFF state that is the default state, and the fifth and eighth line switches 71 and 74 of the second switch part 70 may operate in the ON state.

When the second parking drive circuit 93 (or the second H-bridge circuit 60) fails, the sixth and seventh line switches 72 and 73 of the second switch part 70 may switch from the OFF state to the ON state, and the fifth and eighth line switches 71 and 74 of the second switch part 70 may be kept in the ON state.

In this case, when a failure of the second parking drive circuit 93 (or the second H-bridge circuit 60) is identified, the second MCU 210 may control the operation of the second switch part 70. That is, the second MCU 210 may provide the control signal to the second EPB driving part 220 to switch the sixth and seventh line switches 72 and 73 of the second switch part 70 from the OFF state to the ON state.

According to another embodiment, when the sixth and seventh line switches 72 and 73 are in the ON state, the sixth and seventh line switches 72 and 73 may allow the electric current flow between the second parking drive circuit 93 (or the second H-bridge circuit 60) and the second EPB motor 50. When the fifth and eighth line switches 71 and 74 are in the OFF state, the fifth and eighth line switches 71 and 74 may cut off the electric current flow between the second parking drive circuit 93 (or the second H-bridge circuit 60) and the first EPB motor 10.

In other words, when the second parking drive circuit 93 (or the second H-bridge circuit 60) is in the normal state, the sixth and seventh line switches 72 and 73 of the second switch part 70 may operate in the ON state that is the default state, and the fifth and eighth line switches 71 and 74 of the second switch part 70 may operate in the OFF state.

When the second parking drive circuit 93 (or the second H-bridge circuit 60) fails, the sixth and seventh line switches 72 and 73 of the second switch part 70 may switch from the ON state to the OFF state, and the fifth and eighth line switches 71 and 74 of the second switch part 70 may be kept in the OFF state.

In this case, when a failure of the second parking drive circuit 93 (or the second H-bridge circuit 60) is identified, the second MCU 210 may control the operation of the second switch part 70. That is, the second MCU 210 may provide the control signal to the second EPB driving part 220 to switch the sixth and seventh line switches 72 and 73 of the second switch part 70 from the ON state to the OFF state.

The second MCU 210 may identify whether any one of the plurality of switching elements SW5, SW6, SW7, and SW8 included in the second parking drive circuit 93, more specifically, the second H-bridge circuit 60 fails while the degradation control mode is performed. To this end, the second MCU 210 may receive an electric current value from the second current sensor 80 configured to detect an electric current supplied to the second H-bridge circuit 60. On the basis of the electric current value received from the second current sensor 80, the second MCU 210 may identify whether any one of the plurality of switching elements SW5, SW6, SW7, and SW8 included in the second H-bridge circuit 60 fails.

According to the embodiment, a voltage sensor (not illustrated), instead of a current sensor, may be used to identify whether any one of the plurality of switching elements SW5, SW6, SW7, and SW8 included in the second H-bridge circuit 60 fails.

According to the embodiment, the first MCU 110 and the second MCU 210 may monitor states thereof through internal communication (private communication).

The first MCU 110 and the second MCU 210 may notify whether the first parking drive circuit 92 (or the first H-bridge circuit 20) and the second parking drive circuit 93 (or the second H-bridge circuit 60) fail.

When the first MCU 110 receives, from the second MCU 210, a failure of the second parking drive circuit 93 (or the second H-bridge circuit 60), the first MCU 110 may increase the electric current to be applied to the first parking drive circuit 92 (or the first H-bridge circuit 20) by a value (in some embodiments, selected or predetermined).

When the second MCU 210 receives, from the first MCU 110, a failure of the first parking drive circuit 92 (or the first H-bridge circuit 20), the second MCU 210 may increase the electric current to be applied to the second parking drive circuit 93 (or the second H-bridge circuit 60) by a value (in some embodiments, selected or predetermined).

An operation of the EPB circuit in case that the switching element SW4, among the components of the first parking drive circuit 92, fails will be described with reference to FIG. 9.

The first MCU 110 may identify a failure of the first parking drive circuit 92 (or the first H-bridge circuit 20) on the basis of a change in electric current value received from the first current sensor 40. Therefore, the first MCU 110 may transmit a signal, which indicates a failure of the first parking drive circuit 92 (or the first H-bridge circuit 20), to the second MCU 210. In addition, the first MCU 110 may provide the line switch control signal to the first EPB driving part 120 so that the second and third line switches 32 and 33 of the first switch part 30 operate in the ON state. In this case, the second and third line switches 32 and 33 of the first switch part 30 may switch from the OFF state, which is the default state, to the ON state, and the first and fourth line switches 31 and 34 may be kept in the ON state.

In this case, the second MCU 210 may receive, from the first MCU 110, a signal indicating a failure of the first parking drive circuit 92 (or the first H-bridge circuit 20). Therefore, the second MCU 210 may provide the line switch control signal to the second EPB driving part 220 so that the fifth and eighth line switches 71 and 74 of the second switch part 70 operate in the OFF state. In this case, the sixth and seventh line switches 72 and 73 of the second switch part 70 may be kept in the OFF state that is the default state.

Because the fifth and eighth line switches 71 and 74 switch to the OFF state, the first EPB motor 10 may be electrically connected to the second parking drive circuit 93 through the fifth and eighth line switches 71 and 74 and placed in an operable state.

On the basis that the second MCU 210 receives, from the first MCU 110, the signal indicating a failure of the first parking drive circuit 92 (or the first H-bridge circuit 20), the second MCU 210 may increase the electric current to be applied to the second parking drive circuit 93 (or the second H-bridge circuit 60) by a value (in some embodiments, selected or predetermined).

Therefore, the electric current sufficient for both the first and second EPB motors 10 and 50 to operate in the degradation control mode is supplied through the second parking drive circuit 93, such that the degradation control may be performed without abnormality even in the event of the failure of the first parking drive circuit 92.

According to another embodiment, the second and third line switches 32 and 33 of the first switch part 30 may be in the ON state that is the default state, and the first and fourth line switches 31 and 34 of the first switch part 30 may be in the OFF state. In this case, when the first parking drive circuit 92 (or the first H-bridge circuit 20) fails, the second and third line switches 32 and 33 may switch from the ON state, which is the default state, to the OFF state, and the first and fourth line switches 31 and 34 of the first switch part 30 may be kept in the OFF state. When the first parking drive circuit 92 (or the first H-bridge circuit 20) fails, the second MCU 210 may provide the line switch control signal to the second EPB driving part 220 so that the fifth and eighth line switches 71 and 74 of the second switch part 70 operate in the ON state. In this case, the sixth and seventh line switches 72 and 73 of the second switch part 70 may be kept in the ON state.

An operation of the EPB circuit in case that the switching element SW5, among the components of the second parking drive circuit 93, fails will be described with reference to FIG. 10.

The second MCU 210 may identify a failure of the second parking drive circuit 93 (or the second H-bridge circuit 60) on the basis of a change in electric current value received from the second current sensor 80. Therefore, the second MCU 210 may transmit a signal, which indicates a failure of the second parking drive circuit 93 (or the second H-bridge circuit 60), to the first MCU 110. In addition, the second MCU 210 may provide the line switch control signal to the second EPB driving part 220 so that the sixth and seventh line switches 72 and 73 of the second switch part 70 operate in the ON state. In this case, the sixth and seventh line switches 72 and 73 of the second switch part 70 may switch from the OFF state, which is the default state, to the ON state, and the fifth and eighth line switches 71 and 74 may be kept in the ON state.

In this case, the first MCU 110 may receive, from the second MCU 210, a signal indicating a failure of the second parking drive circuit 93 (or the second H-bridge circuit 60). Therefore, the first MCU 110 may provide the line switch control signal to the first EPB driving part 120 so that the first and fourth line switches 31 and 34 of the first switch part 30 operate in the OFF state. In this case, the second and third line switches 32 and 33 of the first switch part 30 may be kept in the OFF state that is the default state.

Because the first and fourth line switches 31 and 34 switch to the OFF state, the second EPB motor 50 may be electrically connected to the first parking drive circuit 92 through the first and fourth line switches 31 and 34 and placed on an operable state.

On the basis that the first MCU 110 receives, from the second MCU 210, the signal indicating a failure of the second parking drive circuit 93 (or the second H-bridge circuit 60), the first MCU 110 may increase the electric current to be applied to the first parking drive circuit 92 (or the first H-bridge circuit 20) by a value (in some embodiments, selected or predetermined).

Therefore, the electric current sufficient for both the first and second EPB motors 10 and 50 to operate in the degradation control mode is supplied through the first parking drive circuit 92, such that the degradation control may be performed without abnormality even in the event of the failure of the second parking drive circuit 93.

According to another embodiment, the sixth and seventh line switches 72 and 73 of the second switch part 70 may be in the ON state that is the default state, and the fifth and eighth line switches 71 and 74 of the second switch part 70 may be in the OFF state. In this case, when the second parking drive circuit 93 (or the second H-bridge circuit 60) fails, the sixth and seventh line switches 72 and 73 may switch from the ON state, which is the default state, to the OFF state, and the fifth and eighth line switches 71 and 74 of the second switch part 70 may be kept in the OFF state. When the second parking drive circuit 93 (or the second H-bridge circuit 60) fails, the first MCU 110 may provide the line switch control signal to the first EPB driving part 120 so that the first and fourth line switches 31 and 34 of the first switch part 30 operate in the ON state. In this case, the second and third line switches 32 and 33 of the first switch part 30 may be kept in the ON state.

As described above, according to the brake apparatus and the method of controlling the same according to the embodiment, when a failure of any one of the first and second parking drive circuits 92 and 93 is identified while the degradation braking mode is performed in accordance with a failure of the electrohydraulic brake, the other parking drive circuit is controlled to operate the first and second EPB motors 10 and 50, such that the stable braking performance of the brake apparatus may be more securely implemented.

The above description is simply given to illustratively describe the technical spirit of the present disclosure, and those skilled in the art to which the present disclosure pertains will appreciate that various changes and modifications are possible without departing from the essential characteristic of the present disclosure. Therefore, the embodiments disclosed in the present disclosure are provided for illustrative purposes only but are not intended to limit the technical spirit of the present disclosure. The scope of the technical spirit of the present disclosure is not limited thereby. The protective scope of the present disclosure should be construed based on the following claims, and all the technical spirit in the equivalent scope thereto should be construed as falling within the scope of the present disclosure.

1. A brake apparatus comprising:
an electronic parking brake (EPB) installed in each rear wheel of a vehicle;
a first parking drive circuit configured to operate a first EPB motor of the electronic parking brake;
a second parking drive circuit configured to operate a second EPB motor of the electronic parking brake;
a first switch part provided between the first EPB motor and the first parking drive circuit and comprising first and second switches configured to selectively control an electric current flow between the first parking drive circuit and the first EPB motor and an electric current flow between the second parking drive circuit and the first EPB motor;
a second switch part provided between the second EPB motor and the second parking drive circuit and comprising third and fourth switches configured to selectively control an electric current flow between the second parking drive circuit and the second EPB motor and an electric current flow between the first parking drive circuit and the second EPB motor; and
a control unit configured to control the first parking drive circuit and the second parking drive circuit to operate the first EPB motor and the second EPB motor,
wherein when a failure of any one of the first parking drive circuit and the second parking drive circuit is identified, the control unit controls the first switch part or the second switch part connected to any one parking drive circuit with the identified failure and controls the other parking drive circuit to operate the first EPB motor and the second EPB motor.

2. The brake apparatus of claim 1, wherein the control unit comprises:
a first controller configured to control the first parking drive circuit; and
a second controller configured to control the second parking drive circuit.

3. The brake apparatus of claim 2, further comprising:
a first current sensor configured to detect an electric current supplied to the first parking drive circuit from an external power source; and
a second current sensor configured to detect an electric current supplied to the second parking drive circuit from the external power source,
wherein the first controller identifies a failure of the first parking drive circuit on the basis of a signal detected by the first current sensor, and the second controller identifies a failure of the second parking drive circuit on the basis of a signal detected by the second current sensor.

4. The brake apparatus of claim 1, wherein the first switch part is connected to a line extending between the second switch part and the second EPB motor, and the second switch part is connected to a line extending between the first switch part and the first EPB motor.

5. The brake apparatus of claim 4, wherein the first switch part is configured to allow the electric current flow between the first parking drive circuit and the first EPB motor and cut off the electric current flow between the second parking drive circuit and the first EPB motor in a default state, and
wherein the second switch part is configured to allow the electric current flow between the second parking drive circuit and the second EPB motor and cut off the electric current flow between the first parking drive circuit and the second EPB motor in a default state.

6. The brake apparatus of claim 5, wherein the first controller controls the first parking drive circuit to operate the first EPB motor and the second EPB motor in response to the identification of the failure of the second parking drive circuit.

7. The brake apparatus of claim 6, wherein when a failure of the second parking drive circuit is identified, the second controller controls the second EPB driving part to switch the second switch part and transmits a signal, which indicates the failure of the second parking drive circuit, to the first controller, and the first controller increases an electric current to be applied to the first parking drive circuit by a selected electric current value in response to the reception of the signal indicating the failure of the second parking drive circuit.

8. The brake apparatus of claim 5, wherein the second controller controls the second parking drive circuit to operate the first EPB motor and the second EPB motor in response to the identification of the failure of the first parking drive circuit.

9. The brake apparatus of claim 8, wherein when a failure of the first parking drive circuit is identified, the first controller controls the first EPB driving part to switch the first switch part and transmits a signal, which indicates the failure of the first parking drive circuit, to the second controller, and the second controller increases an electric current to be applied to the second parking drive circuit by a selected electric current value in response to the reception of the signal indicating the failure of the first parking drive circuit.

10. The brake apparatus of claim 2, wherein the first controller and the second controller identify states thereof, and when a failure of any one of the first controller and the second controller is identified, the other controller controls the parking drive circuit, which corresponds to the other controller, to operate the first EPB motor and the second EPB motor.

11. A method of controlling a brake apparatus, the method comprising:
identifying a failure of any one of a first parking drive circuit, which is configured to operate a first EPB motor of an electronic parking brake (EPB) installed in each rear wheel of a vehicle, and a second parking drive circuit configured to operate a second EPB motor; and
controlling one of a first switch part or a second switch part, wherein the controlled switch part is connected to any one parking drive circuit with the identified failure and controlling the other parking drive circuit to operate the first EPB motor and the second EPB motor when the failure of any one parking drive circuit is identified,
wherein the first switch part is provided between the first EPB motor and the first parking drive circuit, and comprises first and second switches configured to selectively control an electric current flow between the first parking drive circuit and the first EPB motor and an electric current flow between the first parking drive circuit and the second EPB motor, and
wherein a second switch part is provided between the second EPB motor and the second parking drive circuit and comprises third and fourth switches configured to selectively control an electric current flow between the second parking drive circuit and the second EPB motor and an electric current flow between the second parking drive circuit and the first EPB motor.

12. The method of claim 11, wherein the identifying of the failure of any one parking drive circuit comprises identifying, by first and second controllers, a failure of any one of the first parking drive circuit and the second parking drive circuit on the basis of signals detected by first and second current sensors configured to detect electric currents supplied to the first parking drive circuit and the second parking drive circuit from an external power source.

13. The method of claim 12, wherein the first switch part is connected to a line configured to connect the second switch part and the second EPB motor,
wherein the second switch part is connected to a line configured to connect the first switch part and the first EPB motor, and
wherein the controlling comprises controlling, by the first controller, the first parking drive circuit to operate the first EPB motor and the second EPB motor in response to the identification of the failure of the second parking drive circuit.

14. The method of claim 13, wherein the controlling further comprises:
controlling, by the second controller, the second EPB driving part to switch the second switch part when the failure of the second parking drive circuit is identified; and
transmitting a signal, which indicates the failure of the second parking drive circuit, to the first controller.

15. The method of claim 14, wherein the controlling further comprises:
increasing, by the first controller, an electric current to be applied to the first parking drive circuit by a selected electric current value in response to the reception of the signal indicating the failure of the second parking drive circuit.

16. The method of claim 13, wherein the controlling further comprises:
controlling, by the second controller, the second parking drive circuit to operate the first EPB motor and the second EPB motor in response to the identification of the failure of the first parking drive circuit.

17. The method of claim 16, wherein the controlling further comprises:
controlling, by the first controller, the first EPB driving part to switch the first switch part when the failure of the first parking drive circuit is identified; and
transmitting a signal, which indicates the failure of the first parking drive circuit, to the second controller.

18. The method of claim 17, wherein the controlling further comprises increasing, by the second controller, an electric current to be applied to the second parking drive circuit by a selected electric current value in response to the reception of the signal indicating the failure of the first parking drive circuit.

19. The method of claim 12, further comprising:
identifying, by the first controller and the second controller, states thereof.

20. The method of claim 19, further comprising:
controlling the parking drive circuit corresponding to the other controller so that the other controller operates the first EPB motor and the second EPB motor when a failure of any one of the first controller and the second controller is identified.
